(19) United States
(12) Patent Application Publication
(10) Pub. No.: US 2025/0295944 A1
(43) Pub. Date: Sep. 25, 2025

(54) FIRE-EXTINGUISHING DEVICE TRIGGERED WITH THE AID A SELF-COMBUSTING HEAT-SENSITIVE IGNITER

(71) Applicant: Yuriy Alexandrovich Gabliya, Moscow (RU)

(72) Inventor: Evgenii Sergeevich KAPLUN, Malaya Tsarevshchina (RU)

(21) Appl. No.: 18/862,929

(22) PCT Filed: Jun. 1, 2023
(86) PCT No.: PCT/RU2023/000163

§ 371 Date: Nov. 4, 2024

(30) Foreign Application Priority Data
Jun. 2, 2022 (RU) 2022115002

(51) Int. Cl. A62C 3/16; A62C 37/36; A62C 37/40

(52) U.S. Cl. CPC A62C 3/16; A62C 37/04; A62C 37/40

(57) ABSTRACT

The invention relates to the field of fire-fighting, and more particularly to a fire-extinguishing device in which there is a module (1) containing an aerosol-forming or gas-forming composition, which can be used for the timely protection of electrical panels or enclosures against the effect of high temperatures, for example in the event of a fire. A fire-extinguishing device comprises a housing, wherein the module (1) projects beyond the housing and has disposed thereon a self-combusting heat-sensitive igniter (22) having a trigger temperature that is lower than the trigger temperature of the module (1), the fire-extinguishing device further comprising an activation sensor (11), a button (18) for manually activating an electrical igniter (7) of the module, a contact group (10) for triggering the electrical igniter (7) of the module by means of an external signal sent over conductors or for supplying a trigger voltage to the manual activation button (18), and an electrical igniter (7) of the module. The technical result consists in increasing the timeliness of an initial fire-extinguishing action and more efficiently impeding the spread of fire in an enclosed space such as, in particular, an electrical panel, while simultaneously issuing an information signal to emergency control panels.

### FIELD OF INVENTION

The invention relates to fire-extinguishing devices based on aerosol-forming or gas-forming compounds and can be used to prevent fires in electrical switchboards, safes, cabinets with electrical equipment, cabinets of telecommunications and other electronic equipment located in confined spaces and technical compartments.

When operating electrical equipment, fire often occurs which causes are as follows: overload of electrical installations and wiring, short circuit, ignition of combustible materials near equipment connected to the network, excessive transient resistance in the contact groups of electrical wiring.

It is necessary to duly and automatically suppress the fire at the incipient stage without voltage removal and human intervention, eliminating the possibility of electric shock and preserving expensive equipment.

### STATE OF ART

The fire-extinguishing means that are known from the background of invention and designed to suppress fire in electrical installations are presented below.

An autonomous fire-extinguishing plant based on a thermally activated agent contained in microcapsules (patent RU 179466) which is made of a polymer composite plate having a regular surface relief and containing microcapsules with a fire-extinguishing agent placed in a special organosilicon compound. The substrate of the plate on the reverse side has a heat-resistant self-adhesive layer for its fastening in the protected volume. Microcapsules of 50-400 microns are used as a fire-extinguishing agent, having a core of a fire-extinguishing ozone-safe liquid placed inside a spherical polymer shell (patent RU 2469761). Microcapsules are capable of explosive destruction when the temperature reaches 90° C. This fire-extinguishing system is characterized by a low extinguishing capacity and a short service life (as the application practice shows, it is no more than two years) which is a significant disadvantage.

An autonomous gas fire-extinguishing plant (patent RU 139678) which comprises a cylinder with a gas-extinguishing agent (for example, halon), communicating with a main for supplying a fire-extinguishing medium to a protected volume designed using a fusible polymer material. The main is connected to the cylinder by means of a shut-off and starting device with a pressure gauge and a ball valve, and is also equipped with an elastic outer shell in the form of a metal spiral. This fire-extinguishing plant is characterized by multicomponence and high complexity of installation in a protected volume.

A mean of fastening a fire-extinguishing wire in an electric cabinet is known (patent RU 190409). A fire-extinguishing wire or pyrowire is an autonomous fire-extinguishing plant with a thermally activated microcapsulated fire-extinguishing agent designed to provide protection against fires in large-sized fire-hazardous facilities with electrical equipment such as switchboards, control cabinets, electrical cabinets, safes, etc. The technique according to this patent is a device holding a fire-extinguishing wire in an electric cabinet, having a support for fastening to the inner walls of the electric cabinet and designed in the form of a bending mount having a slot for holding the wire, and the base of the mount has an adhesive layer. The disadvantage of this technique is the complexity of a fire-extinguishing wire installation, associated with the need to install the claimed mean of fastening to the inner walls of the electrical cabinet along its perimeter, after which the fire-extinguishing wire is fastened in the mount.

A self-working fire-extinguishing device is known (patent RU 184841) which contains a foam housing comprising an explosive device and a fire-extinguishing agent. The explosive device is connected to a fire-conducting wire extending outward through the housing hole, and laid in a closed recess designed from the outside of the housing along its perimeter, and the width of the recess exceeds the width of the fire-conducting wire. To facilitate the rupture of the housing when an explosive device is triggered, grooves are designed on the inside of the housing. This device is suspended from a bracket or placed on a flat surface and independently activates when the flame contacts the fire-conducting wire. The disadvantage of this technique is that the fire-extinguishing device is placed in a guarded room with electrical equipment using a bracket or installed on a flat surface limiting its location options and reduces the effectiveness of fire extinguishing.

An automatic fire-extinguishing device for telecommunication equipment is known which is placed in a standard closed-type telecommunications rack (TCR) (patent RU 190222). The device is a single structure containing a housing comprising a flame-extinguishing agent generator (FEAG); the flame-extinguishing agent generator consists of two containers that are connected to a flame-extinguishing agent delivery system to the ignition source, consisting of pipelines and FEAG nozzles. The device triggering unit is designed in the form of an external linearly extended sensor, which is routed through the most heat-loaded areas of the TCR and connected to the input of the device, which, in turn, is connected inside the device to a sensor exceeding the temperature threshold. Additionally, this device comprises an alarm device (a light and sound indicator) indicating the fact that the generator has produced a flame-extinguishing agent. In this automatic fire-extinguishing device, standard flame-extinguishing agents are offered for use; they are characterized by insufficient extinguishing capacity and are unsafe in their chemical composition. It reduces the effectiveness of extinguishing, and the presence of pipelines and nozzles for supplying a flame-extinguishing agent to a guarded room increases the complexity of manufacturing the device, as well as installing the device in other types of rooms with electrical equipment is characterized by increased complexity of manufacturing in due to the use of standard methods of fastening to the TCR.

An autonomous fire-extinguishing device with a fastening on a DIN rail is known (patent RU 204767), comprising a housing that has a fire-extinguishing aerosol generator (FAG) with a triggering unit is located; FAG is constructed in the form of a housing designed using a non-flammable material with an outlet nozzle into which an aerosol-forming or gas-forming composition (AFC) is placed, and the housing of automatic firefighting system comprises nozzle openings for the output of an acrosol-forming or gas-forming composition and a slot for attaching the housing from FAG to a DIN rail, and the triggering unit comprises the form of a self-igniting thermal wire. Preferably, the triggering unit comprises the form of a self-igniting thermal wire with a heat-sensitive clement; the activation temperature is less than the activation temperature of the thermal wire. The disadvantage of this device is that it is not capable of being triggered by an external signal or create a start signal for the control automation significantly reducing the range of application of the device. The aerosol-forming composition triggering system is also represented by a mounted thermal wire with a heat-sensitive element applied to it which significantly increases the risk of failure of the automatic firefighting system if the thermal wire breaks during operation of the device. This technique is the closest analogous solution to the claimed utility model and can act as a prototype.

### DISCLOSURE OF INVENTION

The technical problem that the claimed solution is aimed at solving is the creation of a compact fire-extinguishing device for electrical equipment located in switchboards, electrical cabinets, cabinets of telecommunications equipment, etc., with high fire-extinguishing capacity, a wide range of operational capabilities either with the possibility of attaching the proposed device to a DIN rail or without it, having the possibility of initiation by an external electrical signal or initiation from a self-igniting thermal igniter applied, as well as capable of generating an information signal of the device's triggering.

The technical result of the claimed patent is to solve the specified technical problem and implement the claimed fire-extinguishing device triggered with a self-combusting heat-sensitive igniter.

The achievement of this technical result is carried out due to a fire extinguishing device (FED) with an aerosol-forming or gas-forming composition (module) placed inside, comprising FED housing and characterized in that the module (1) protrudes beyond the FED housing and contains a self-igniting thermal igniter (22) having a triggering temperature lower than the module (1) triggering temperature; electric igniter (7) of the module.

Alternatively, the FED additionally comprises a contact group (10) for triggering through conductors by an external signal of the electric igniter (7) of the module; a triggering sensor (11) and a manual start button (18) of the electric igniter (7) of the module; a triggering sensor (11) is connected by conductors (17) to the contact group (10); the manual start button (18) of the electric igniter (7) of the module is connected via conductors to the electric igniter (7) of the module and the contact group (10).

Alternatively, the aerosol-forming or gas-forming composition of the FED is a low-temperature solid fuel composition.

Alternatively, the FED housing is made in the form of a typical modular electrical device, and the device is additionally designed for mounting on a DIN rail; the DIN rail mount is a slot for a DIN rail located on the back of the device housing, in which a latch-mount is installed to fasten the housing on a DIN rail.

Alternatively, holes are additionally configured with a housing comprising holes for the output of an aerosol-forming or gas-forming composition.

### EMBODIMENT OF INVENTION

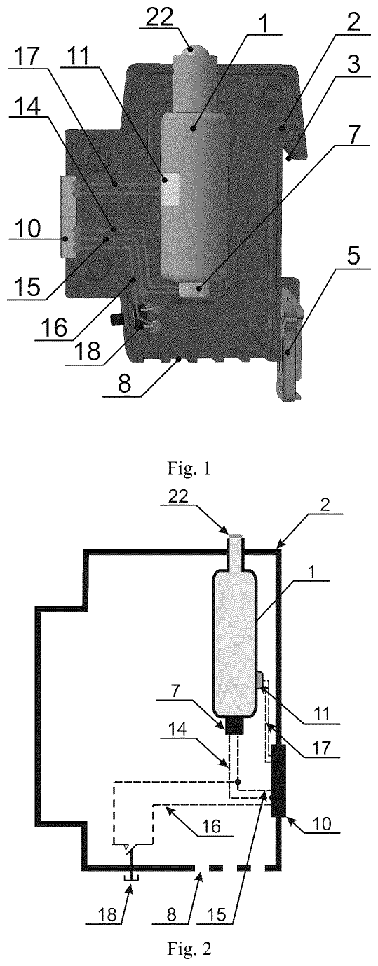

FIG. 1 and FIG. 2 show the type and scheme of the claimed FED, where 1 is the module, 2 is the FED housing for installation, 3 is the slot for attaching the housing to a DIN rail, 5 is the latch-mount, 7 is the electric igniter of the module, 8 are nozzle openings for the outlet of aerosol-forming or gas-forming composition, 10 is the contact group for connecting external wires for the electric igniter of the module (7) and the manual start button (18), 11 is a module triggering sensor, (14-15) are conductors for external triggering of the electric igniter of the module, (14-16) are conductors for triggering the module (1) through the manual start button (18), 17 are conductors connecting the contact group to the module triggering sensor, 18 is the manual start button of the module's electric igniter triggering, 22 is a self-igniting thermal igniter.

The FED comprises a module (1) and a compact housing (2). The housing of the FED can be made in the form of a typical modular electrical device. The module (1) is located in the housing (2), in which nozzle openings are made for the outlet of an aerosol-forming or gas-forming composition (8), and the triggering unit of the module (1) is a module (1) protruding outside the housing of the FED comprising a self-igniting thermal igniter (22) having a triggering temperature lower than the temperature triggering the module (1).

When a fire occurs in an electric cabinet, when the operating temperature of the module (1) is reached, determined by the properties of the self-igniting thermal igniter (22), the module (1) is triggered, an acrosol-forming or gas-forming composition begins to exit from the housing (2) through the nozzle openings (8) according to FIGS. 1 and 2, an acrosol-forming or gas-forming composition in the form of a gaseous mixtures, filling the protected volume of the switchboard and suppressing the combustion of the components of the switchboard. At the same time, the module triggering sensor (11) is triggered, which gives a signal to the external automation about the beginning of the fire extinguishing process.

In the case of voltage supply through the contact group (10) and wires (14) (15) to the electric igniter (7) of the module, the module (1) is also triggered allowing remote triggering of the FED by means of an external signal.

The module triggering sensor (11), necessary for generating the trigger signal of the module (1), is connected by conductors (17) to the contact group (10), and in the said contact group (10) separate contacts are used for the said connection.

The back of the FED's housing (2) comprises a slot (3); the slot comprises a latch-mount (5) designed to fasten the housing (2) to a DIN rail. At the same time, the housing of the FED can also be fastened to the DIN rail using a screw connection, however, fastening with a DIN rail assembly with a latch-mount (5) is advantageous, because it makes it possible to install the FED in a larger range of locations in the switchboard or cabinet, which leads to increased fire-extinguishing efficiency. Preferably, the specified technical result is achieved in the device by mounting the FED on a DIN rail as follows. The latch-mount (5) is pushed down, the housing (2) with the module (1) installed in it is placed on the DIN rail, clinging to the upper protrusions of the slot (3), after which the latch-mount (5) closes fastening the FED on the DIN rail. The removal of the FED from the DIN rail is carried out in reverse order. Thus, the use of the claimed FED, with the simplicity and compactness of the design, autonomy and reliability of operation, and the simplicity of its installation on a DIN rail, allows to extinguish fire in the electrical equipment located in cabinet-type rooms with high efficiency.

1. A fire extinguishing device (FED) with an aerosol-forming or gas-forming composition (module) placed inside the module comprising the FED housing, characterized in that the module (1) protrudes beyond the FED housing and comprises a self-igniting thermal igniter (22) having a triggering temperature lower than the triggering temperature of the module (1). In addition, it comprises a triggering sensor (11) and a manual start button (18) of the electric igniter (7) of the module, a contact group (10) for triggering through conductors by an external signal of the electric igniter (7) of the module or the supply of a triggering voltage to the manual start button (18) and the electric igniter (7) of the module.

2. A device according to claim 1, characterized by the triggering sensor (11) which is connected by conductors (17) to the contact group (10); the manual start button (18) of the electric igniter (7) of the module is connected through conductors to the electric igniter (7) of the module.

3. A device according to claim 1, characterized by a low-temperature solid fuel aerosol-forming or gas-forming composition.

4. A device according to claim 1, characterized by the housing of the FED which is made in the form of an electrical device of a modular type, and the device is additionally designed for mounting on a DIN rail, the DIN rail fastening is a slot for a DIN rail located on the back side of the device housing, in which a latch-mount is installed for fastening the housing on a DIN-rail.

5. A device according to claim 1, characterized by additional housing holes for the output of an aerosol-forming or gas-forming composition.
